(19) United States
(12) Patent Application Publication
(10) Pub. No.: US 2024/0362998 A1
(43) Pub. Date: Oct. 31, 2024

(54) Devices and Methods Therein for Uploading Data

(71) Applicant: Telefonaktiebolaget LM Ericsson (publ), Stockholm (SE)

(72) Inventors: Yinsheng Chen, Guangzhou (CN); Meimei Chen, Guangzhou (CN)

(21) Appl. No.: 18/685,980

(22) PCT Filed: Aug. 23, 2021
(86) PCT No.: PCT/CN2021/114081

§ 371 Date: Feb. 23, 2024

(51) Int. Cl. G08G 1/01; H04W 4/021; H04W 4/44

(52) U.S. Cl. CPC G08G 1/0112; G08G 1/0125; H04W 4/021; H04W 4/44

(57) ABSTRACT

A method in a control entity, the method includes receiving a location information of a terminal device from a service entity, wherein the location information indicates the terminal device moves into or out of a target area; the method further includes: determining an upload interval parameter for the terminal device based on the location information, wherein the upload interval indicates a period for the terminal device to upload the terminal device related information to a server entity.

### TECHNICAL FIELD

The present disclosure relates to IoT (Internet of Things) technology, and more particularly, to methods and devices therein for dynamically uploading data from the vehicles to the server.

### BACKGROUND

This section introduces aspects that may facilitate a better understanding of the disclosure. Accordingly, the statements of this section are to be read in this light and are not to be understood as admissions about what is in the prior art or what is not in the prior art.

With rapid development on automotive industry, telematics has become a mandatory function in connected vehicles, as shown in FIG. 1. TBox (Telematics Box), also called telematics control unit (TCU), is a device which consists of microcontrollers, GPS (Global Positioning System) unit, electronic processing units, mobile communication units, etc., enabling communications between the car (10) and the cloud server shown as CV (Connected Vehicle) backend (20) in FIG. 1. The communication system between them can be 4G (4^{th} Generation) or 5G (5^{th} Generation) wireless communication system. In a connected vehicle, TBox collects basic information of vehicle in real time, such as speed, location, fuel consumption and other information, then uploads it periodically to the cloud applications.

### SUMMARY

Currently in Connected Vehicle industry, vehicles use TBox to upload vehicle's information to the cloud server periodically, for example, per 1 second, this will generate a large amount of data every day, which requires large data storage memory in the cloud server.

But when the vehicle is running on the high-speed roads or on the traffic jam, some of the data, such as speed and location information, changes very small, therefore most of these data are redundant. When we analyze these data at the backend, it would cost much time and resource to clean these redundant data.

To overcome or mitigate at least one above mentioned problems or other problems or provide a useful solution, the embodiments of the present disclosure propose an improved context resume solution. This invention introduces a new method for make connected vehicle to upload vehicle's information dynamically in different scenarios.

According to a first aspect of the present disclosure, a method in control entity is provided. The method includes, receiving a location information of a terminal device from a service entity, the location information indicates the terminal device moves into or out of a target area; the method further includes determining an upload interval parameter for the terminal device based on the location information, the upload interval indicates a period for the terminal device to upload the terminal device related information to a server entity.

In an embodiment, the method may further comprise sending the upload interval parameter to the terminal device to configure the terminal device to upload the terminal device related information to the server entity.

In an embodiment, the method may further comprise sending a first request message for the location information of the terminal device to the service entity, the first request message may include an identifier of the terminal device and information of the target area.

In an embodiment, the first request message may be an edge service subscription message to subscribe the location information from the service entity.

In an embodiment, the method may further comprise determining when to send the edge service subscription message.

In an embodiment, the determining the upload interval parameter may comprise the control entity may set the upload interval parameter to be a first parameter when the location information indicates that the terminal device moves into the target area; the control entity may set the upload interval parameter to be a second parameter when the location information indicates that the terminal device moves out of the target area.

In an embodiment, the first parameter is larger than the second parameter.

In an embodiment, the terminal device related information comprises at least one the following: speed of the terminal device, location of the terminal device.

In an embodiment, the information of the target area may be the geographical area information which comprises at least one of the following: a geographical information of a high-speed way, a geographical information of a congested street.

In an embodiment, the terminal device may be a vehicle, a mobile phone or a drone.

According to a second aspect of the present disclosure, a method in a service entity is provided. The method includes, obtaining a location information of a terminal device, the location information indicates the terminal device moves into or out of a target area; the method further includes sending the location information of the terminal device to a control entity.

In an embodiment, the method may further comprise receiving a first request message for the location information of the terminal device from the control entity, wherein the first request message includes an identifier of the terminal device and information of the target area.

In an embodiment, the first request message may be an edge service subscription message to subscribe the location information from the service entity.

In an embodiment, the obtaining the location information may comprise sending a second request message for the location information of the terminal device to a core network entity, and receiving the location information of the terminal device from the core network entity.

In an embodiment, the method may further comprise determining the terminal device moves into or out of the target area which is served by the service entity.

According to a third aspect of the present disclosure, a method in a terminal device is provided. The method includes, receiving an upload interval parameter for the terminal device from a control entity, uploading the terminal device related information to a server entity based on the upload interval parameter.

In an embodiment, the upload interval parameter is the first parameter when the terminal device moves into the target area; the upload interval parameter is the second parameter when the terminal device moves out of the target area.

In an embodiment, the first parameter is larger than the second parameter.

According to a fourth aspect of the present disclosure, a control entity is provided. The control entity includes a processor and a memory coupled to the processor, the memory contains instructions executable by the processor, the control entity is operative to receive a location information of a terminal device from a service entity, wherein the location information indicates the terminal device moves into or out of a target area; and determine an upload interval parameter for the terminal device based on the location information, wherein the upload interval indicates a period for the terminal device to upload the terminal device related information to a server entity.

According to a fifth aspect of the present disclosure, a service entity is provided. The service entity includes a processor and a memory coupled to the processor, the memory contains instructions executable by the processor, the service entity is operative to obtain a location information of a terminal device, wherein the location information indicates the terminal device moves into or out of a target area; and send the location information of the terminal device to a control entity.

According to a sixth aspect of the present disclosure, a terminal device is provided. The terminal device includes a processor and a memory coupled to the processor, the memory contains instructions executable by the processor, the terminal device is operative to receive an upload interval parameter for the terminal device from a control entity, upload the terminal device related information to a server entity based on the upload interval parameter.

According to a seventh aspect of the present disclosure, a computer-readable storage medium is provided. The computer-readable storage medium has computer-readable instructions stored thereon. The computer-readable instructions, when executed by a processor of a control entity, configure the control entity to, perform the method according to the above first aspect, or when executed by a processor of a service entity, configure the service entity to, perform the method according to the above second aspect, or when executed by a processor of a terminal device, configure the terminal device to, perform the method according to the above third aspect.

According to a seventh aspect of the present disclosure, a computer program product may be configured as a computer program code structured in computer program modules. The computer program modules could essentially perform the method according to the above first or second or third aspect.

With the embodiments of the present disclosure, some advantages can be achieved. Since the vehicle's information can be uploaded to the could server dynamically, not limited to a fixed number (for example, per 1 second), the data amount uploaded can be reduced, therefore the wireless communication resources used to upload the data can be saved; and when analyzing these data, the time and resources for cleaning the redundant data is also saved.

### BRIEF DESCRIPTION OF THE DRAWINGS

The above and other objects, features and advantages will be more apparent from the following description of embodiments with reference to the figures, in which:

FIG. 1 is a block diagram showing the existing vehicle system;

FIG. 2 is a block diagram showing the 5G Core network;

FIG. 3 is a block diagram showing an exemplary embodiment of the present disclosure;

FIG. 4a is a flowchart illustrating a method in a control entity according to an embodiment of the present disclosure;

FIG. 4b is a flowchart illustrating a method in a control entity according to another embodiment of the present disclosure;

FIG. 5a is a flowchart illustrating a method in a service entity according to an embodiment of the present disclosure;

FIG. 5b is a flowchart illustrating a method in a service entity according to another embodiment of the present disclosure;

FIG. 6 is a flowchart illustrating a method in a terminal device according to an embodiment of the present disclosure;

FIG. 7 is a sequence diagram of the system according to an embodiment of the present disclosure;

FIG. 8 is a sequence diagram of the system according to another embodiment of the present disclosure;

FIG. 9 is a sequence diagram of the system according to another embodiment of the present disclosure;

FIG. 10 is a block diagram of an entity/device structure according to still one embodiment of the present disclosure; and

FIG. 11 is a block diagram of a control entity according to another embodiment of the present disclosure.

FIG. 12 is a block diagram of a service entity according to another embodiment of the present disclosure.

FIG. 13 is a block diagram of a terminal device according to another embodiment of the present disclosure.

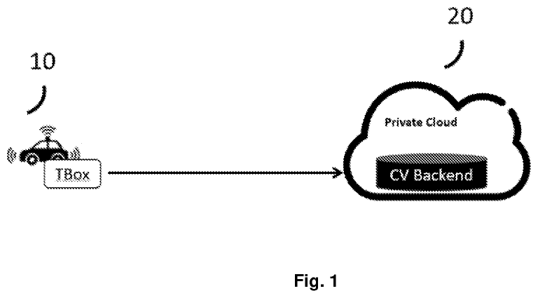

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

The term “entity” used herein refers to a network entity in a communication network. The “entity” can be implemented in a physical network node, or in a virtual network node which perform a function by logical resources in more than one physical network node. The “entity” can be implemented in a centralized way, or in a distributed way. The “entity” can also be implemented in the cloud.

In the context of Internet of Things (IOT), a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP (3rd Generation Partnership Project) context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. For example, a terminal device may represent a vehicle or a drone or other equipment that is capable of monitoring and/or reporting on its operational status or other functions associated with its operation.

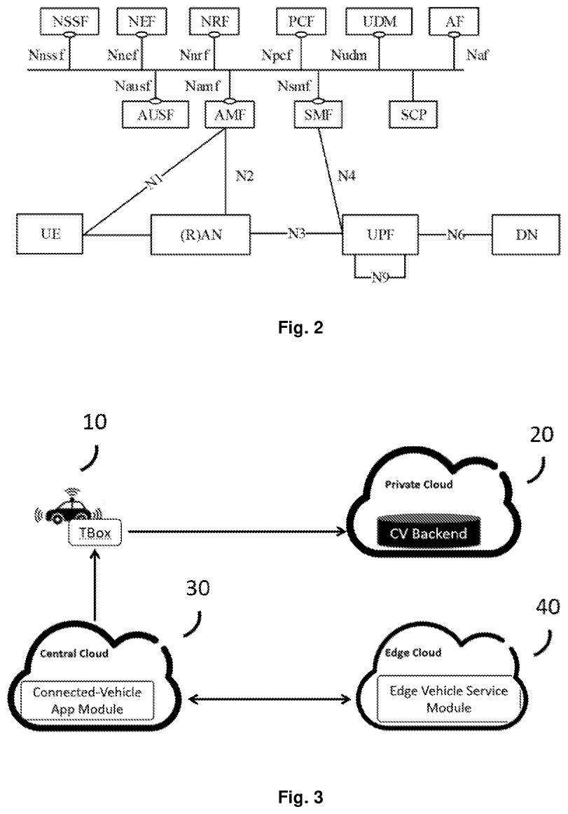

FIG. 2 schematically shows a high level architecture in the next generation network such as 5G. The system architecture of FIG. 2 may comprise some exemplary elements such as UE (User Equipment), AMF (Access and mobility Function), SMF (Session Management Function), AUSF (Authentication Service Function), UDM (Unified Data Management), PCF (Policy Control Function), AF (Application Function), NSSF (Network Slice Selection Function), NEF (Network Exposure Function), UPF (User plane Function) and NRF (NF Repository Function), (R) AN ((Radio) Access Network), SCP (Service Communication Proxy), DN (Data Network), etc.

As further illustrated in FIG. 2, the exemplary system architecture also contains the service-based interfaces such as Nnrf, Nnef, Nausf, Nudm, Npcf, Namf and Nsmf exhibited by NFs such as the NRF, the NEF, the AUSF, the UDM, the PCF, the AMF and the SMF. In addition, FIG. 2 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

The positioning of a terminal device (called UE in 3GPP standard) can be performed by either 3GPP access network or non-3GPP access network as described in the standard 3GPP TS 23.273 V16.7.0 (2021-06) (Herein the contents of standard 3GPP TS 23.273 V16.7.0 are all incorporated in the invention.). A proper access type shall be determined to assure that the positioning result can fulfil the requested QoS and operator policy.

Location information for one or multiple target terminal devices may be requested by and reported to an LCS (Location Services) client or an AF. An LCS client or AF sends a location request to a PLMN (Public Land Mobile Network) for a target terminal and expects to receive a response containing the indication of event occurrence and location information if requested for the target terminal device at some future time which may be associated with specific events associated with the target terminal device.

One important event defined is “Area event”: An event where the UE enters, leaves or remains within a pre-defined geographical area. At least one type of area event can be defined (i.e., entering, leaving or remaining within the area). The LCS client or AF may define the target area as a geographical area or as a geopolitical name of an area. The PLMN may translate and define the target area as the identities of one or more radio cells or tracking areas. The area event may be reported one time only, or multiple times.

FIG. 3 illustrates the architecture of this invention. TBox (10) is installed in the connected vehicle, it can collect information of the vehicle itself or from other devices within the vehicle, for example different type of sensors. Then TBox will upload the vehicle information to CV backend (20). The data can be transmitted via wireless network, for example 4G or 5G network. Normally, the information upload interval is a fixed number, e.g., 1 second. In this invention, the interval can be configured dynamically by the Connected-Vehicle App Module (30).

CV Backend (20) is a platform to receive the real-time data from vehicles and store the data. And optionally, the data can be further processed, for example, data cleaning and analysis can be made within the CV Backend. CV Backend (30) is usually deployed in Vehicle vendor's private network. It can be implemented in a server as a physical node, or it can be implemented in a cloud.

Connected-Vehicle App Module (30) is responsible for adjusting upload interval in TBox according to the information from Edge Vehicle Service module to avoid the high frequency upload of the abundant data. When the Connected-Vehicle App Module determines the upload interval should be changed, it sets a new upload interval and sends it to the TBox in the vehicle. And upload interval can also be changed back to the old upload interval by the Connected-Vehicle App Module. The Connected-Vehicle App Module can be implemented in a separate physical node or a separate cloud, and it may also be implemented in the same physical node or a same cloud with the Edge Vehicle Service module.

Edge Vehicle Service module (40) is responsible for obtaining the location information of whether the vehicle is moving into the target area or is moving out of the area from the core network and then offer this information to the registered Connected-Vehicle App Module. Edge Vehicle Service module acts as the LCS client or an AF as described in 3GPP TS 23.273 V16.7.0 in which how to obtain the location information is described in detail. The Edge Vehicle Service module just need to subscribe the request to the core network, then it can receive the information/notification. Edge Vehicle Service module can be deployed in the edge near the target area to offer the service for the target area.

This invention proposes a method for Connected Vehicle App module to integrate with Edge Vehicle Service module to dynamically register specific location area vehicle information, and dynamically reset the information upload interval in TBox to reduce the real-time data upload frequency in some special scenarios.

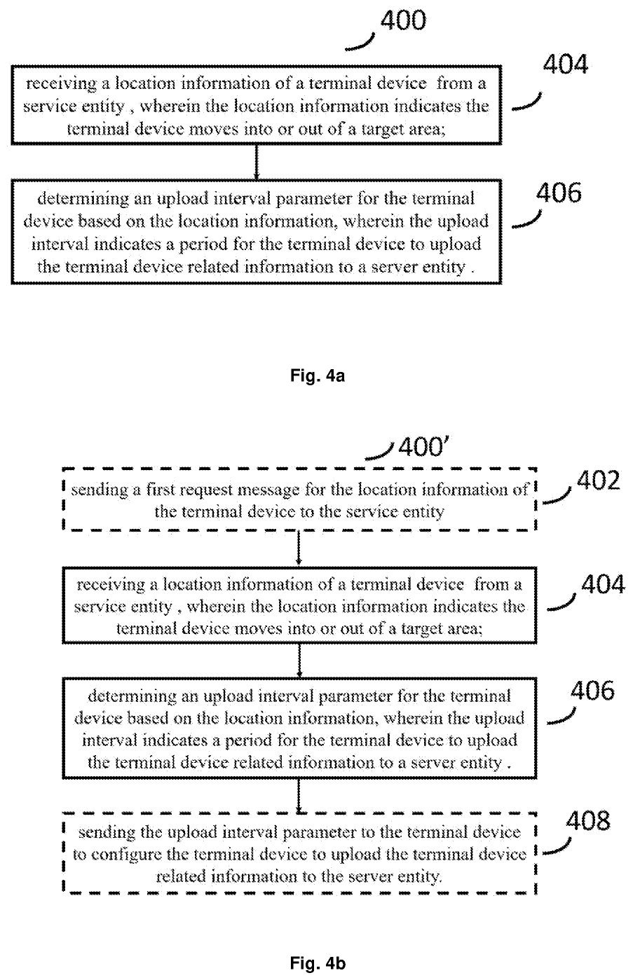

FIG. 4a and FIG. 4b shows flowcharts of methods 400,400′ according to an embodiment of the present disclosure, which may be performed by an apparatus implemented in or at or as a control entity or communicatively coupled to the control entity. As such, the apparatus may provide means or modules for accomplishing various parts of the method 400,400′ as well as means or modules for accomplishing other processes in conjunction with other components.

The control entity acts as the parameter controller of the terminal device. It can be implemented as Connected-Vehicle App Module (30) above. The control entity is responsible for adjusting upload interval in terminal device according to the information from the service entity to avoid the high frequency upload of the abundant data.

At block 402, optionally, the control entity sends a first request message for the location information of the terminal device to the service entity. The first request message may include an identifier of the terminal device and/or information of the target area. The terminal device may be a vehicle or a drone or other equipment that is capable of monitoring and/or reporting on its operational status or other functions associated with its operation. The service entity is responsible for obtaining the location information of whether the terminal device is moving into the target area or is moving out of the area from the core network based on the identifier of the terminal device and/or information of the target area and then offer this location information to the control entity.

The identifier of the terminal device is a unique identifier that can be used to label the terminal device or part of the terminal device, it can be implemented in various format, for example IMSI (International Mobile Subscriber Identity). The information of the target area can be the geographical information of the specific area, the specific area may be a pre-defined area, for example a high-speed way, or a street which may be congested. The geographical information can be in various format, for example a shape defined in 3GPP TS 23.032 V17.0.0 (Herein the contents of standard 3GPP TS 23.032 V17.0.0 are all incorporated in the invention), or local coordinate system for LCS Client e.g., using the OMA MLP (Mobile Location Protocol) protocol, or other latitude and longitude information that can be used to label the specific area.

The location information of the terminal device can be various. Optionally, the speed of the terminal device, and/or location of the terminal device are preferred.

The first request message can be implemented in various ways to request the location information from the service entity. In an embodiment, the first request message can be an edge service subscription message to subscribe the location information from the service entity. In one way, when the service entity gets the location information, it will send the location information immediately to the control entity; in another way, when the service entity knows that the location information changes, it will send the location information; in another way, the service entity sends the location periodically.

At block 404, the control entity receives the location information of a terminal device from a service entity.

At block 406, the control entity determines an upload interval parameter for the terminal device based on the location information. The upload interval indicates a period for the terminal device to upload the terminal device related information to a server entity. The server entity is server or platform to receive the real-time data from the terminal device and store the data. And optionally, the data can be further processed, for example, data cleaning and analysis can be made within the server entity. The server entity can be implemented as CV Backend (30) above.

Upon receiving the location information from the service entity, the control entity will know the events that the terminal is moving in or out of the target area, it will determine the upload interval parameter based on the events. For example, if the location information indicates that the vehicle moves in the high-speed way, it will set the upload interval parameter to be a first parameter, for example 10 seconds, and the vehicle will upload its information to the server entity every 10 seconds; if the location information indicates that the vehicle moves out of the high-speed way, it will set the upload interval parameter back to a second parameter, for example 1 second, and vehicle will upload its information to the server entity every 1 seconds as normal.

At block 408, the control entity sends the upload interval parameter to the terminal device to configure the terminal device to upload the terminal device related information to the server entity. After the control entity has determined the upload interval parameter, it sends the upload interval parameter to the terminal device. For example, if the upload interval parameter has been set to be 10 seconds, the control entity sends it to the terminal device to configure the terminal device to upload the terminal device related information to the server entity every 10 seconds. If the upload interval parameter has been set to be 1 seconds, the control entity sends it to the terminal device to configure the terminal device to upload the terminal device related information to the server entity every 1 seconds as normal.

With the embodiments of the present disclosure, the vehicle's information can be uploaded to the could server dynamically, not limited to a fixed number (for example, per 1 second), the data amount uploaded can be reduced, therefore the wireless communication resources used to upload the data can be saved.

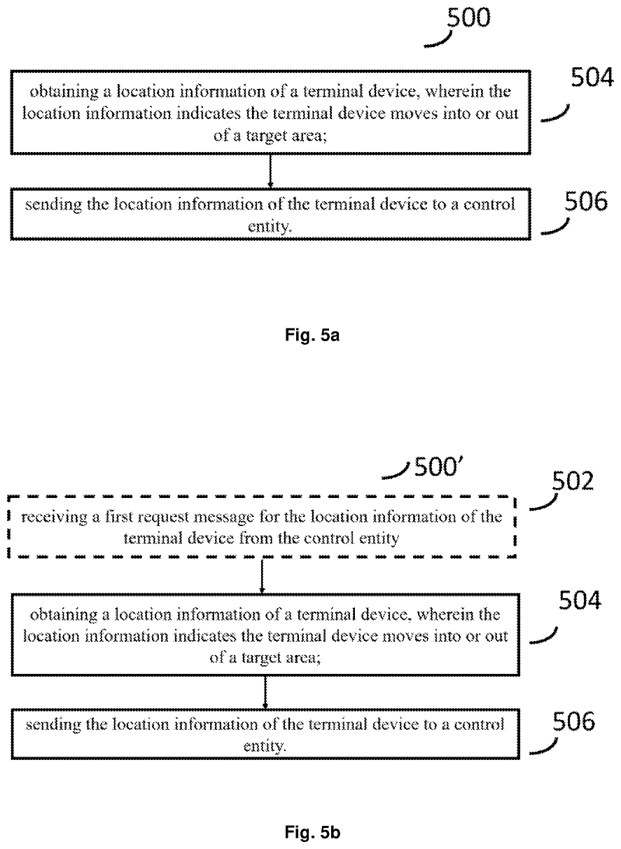

FIG. 5a and FIG. 5b shows flowcharts of methods 500,500′ according to an embodiment of the present disclosure, which may be performed by an apparatus implemented in or at or as a service entity or communicatively coupled to the service entity. As such, the apparatus may provide means or modules for accomplishing various parts of the method 500,500′ as well as means or modules for accomplishing other processes in conjunction with other components.

The service entity is responsible for obtaining the location information of whether the terminal device is moving into the target area or is moving out of the area from the core network based on the identifier of the terminal device and/or information of the target area and then offer this location information to the control entity. It can be implemented as Edge Vehicle Service Module (40) above.

At block 502, optionally, the service entity receiving a first request message for the location information of the terminal device from the control entity. The first request message may include an identifier of the terminal device and/or information of the target area.

The terminal device may be a vehicle or a drone or other equipment that is capable of monitoring and/or reporting on its operational status or other functions associated with its operation.

The identifier of the terminal device is a unique identifier that can be used to label the terminal device or part of the terminal device, it can be implemented in various format, for example IMSI (International Mobile Subscriber Identity). The information of the target area can be the geographical information of the specific area. The specific area can be various, for example a high-speed way, or a street which may be congested. The geographical information can be in various format, for example a shape defined in 3GPP TS 23.032 V17.0.0 (Herein the contents of standard 3GPP TS 23.032 V17.0.0 are all incorporated in the invention), or local coordinate system for LCS Client e.g., using the OMA MLP (Mobile Location Protocol) protocol, or other latitude and longitude information that can be used to label the specific area.

The location information of the terminal device can be various. Optionally, the speed of the terminal device, and/or location of the terminal device are preferred.

The first request message can be implemented in various ways to request the location information from the service entity. In an embodiment, the first request message can be an edge service subscription message to subscribe the location information from the service entity. In one way, when the service entity gets the location information, it will send the location information immediately to the control entity; in another way, when the service entity knows that the location information changes, it will send the location information; in another way, the service entity sends the location periodically.

At block 504, the service entity obtains the location information of a terminal device, the location information indicates the terminal device moves into or out of a target area. The service entity can obtain the location information of a terminal device in various ways. One preferred way is to obtain the location information from core network. For example, the service entity can send a second request message for the location information of the terminal device to a core network entity, and after core network entity gets the location information, it will send the location information to the service entity. As how core network entity gets the location information of the terminal device, it is described in detail in the standard 3GPP TS 23.273 V16.7.0 (2021-06) (Herein the contents of standard 3GPP TS 23.273 V16.7.0 are all incorporated in the invention).

At block 506, the service entity sends the location information of the terminal device to the control entity. After obtaining the location information of a terminal device, the service entity sends it to the control entity so that the control entity can configure the terminal device to set the upload interval parameter as described above.

With the embodiments of the present disclosure, the service entity can obtain quickly the location information of whether the vehicle moves into or out of the target area from the core network, the accuracy of the location information is precise. And with this location information, the control entity can set the upload interval of the vehicle dynamically to help reduce the large amount of data to be uploaded.

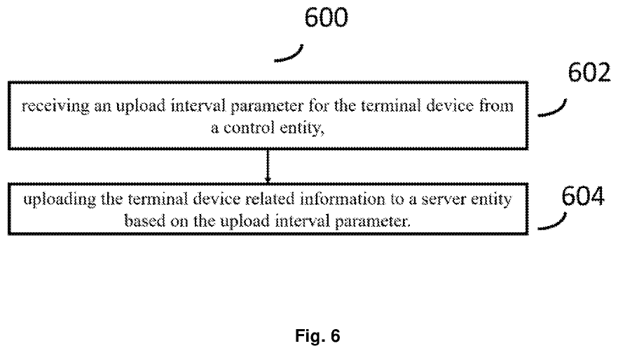

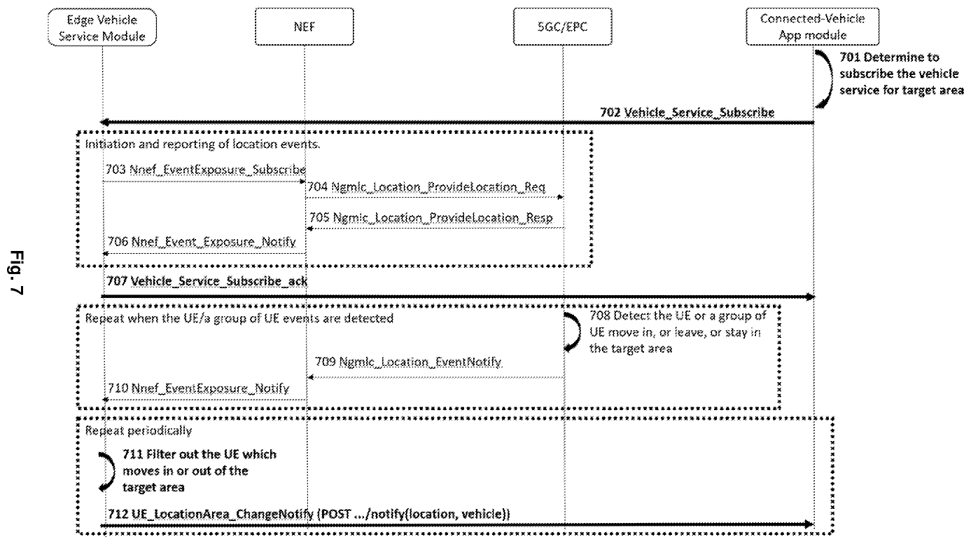

FIG. 6 shows flowcharts of methods 600 according to an embodiment of the present disclosure, which may be performed by an apparatus implemented in or at or as a terminal device or communicatively coupled to the service entity. As such, the apparatus may provide means or modules for accomplishing various parts of the method 600 as well as means or modules for accomplishing other processes in conjunction with other components.

The terminal device may be a connected vehicle or a drone or other equipment that is capable of monitoring and/or reporting on its operational status or other functions associated with its operation. It can be implemented as TBOX in the vehicle (10) shown in FIG. 3.

At block 602, the terminal device receives an upload interval parameter for the terminal device from a control entity. The control entity acts as the parameter controller of the terminal device. It can be implemented as Connected-Vehicle App Module (30) above.

The upload interval parameter has been set by the control entity. For example, it can be set to a first parameter, for example 10 seconds when the vehicle moves into the highway; it can be set back to a second parameter, for example 1 second when the vehicle moves out of the highway.

At block 604, the terminal device uploads the terminal device related information to a server entity based on the upload interval parameter. For example, if the upload interval parameter is 10 seconds, the vehicle will upload the status data to the server every 10 seconds, which means that when the vehicle moves into the highway, it's speed may not change for a long time, there is no need to upload its speed information so frequently, the data amount to be uploaded can be reduce dramatically. If the upload interval parameter is 1 seconds, the vehicle will upload the status data to the server every 1 seconds. which means that when the vehicle moves out of the highway, the vehicle will upload it status data to the server as usual.

With the embodiments of the present disclosure, the vehicle's information can be uploaded to the could server dynamically, not limited to a fixed number (for example, per 1 second), the data amount uploaded can be reduced, therefore the wireless communication resources used to upload the data can be saved.

FIG. 7 shows the procedure to get the UE event of move in/leave target area.
Step 701, the Connected-vehicle app module determines when to subscribe the Edge Vehicle Service to receive the vehicles and the location information when the vehicles move in or leave the target area. It can use the AI (Artificial Intelligence)/ML (Machine Learning) to define the timeframe of subscribe/unsubscribe of the Edge Vehicle Service smartly and save the cost of the Edge Vehicle Service.
Step 702, Connected-Vehicle app module subscribes the vehicle-service to the Edge Vehicle Services module. There are multiple Edge Vehicle Services for the app to subscribe and which services are selected are mainly based on the target areas. In the subscription, it needs to offer the vehicles' IMSI and the target area's location information.
Step 702, Edge Vehicle Services module subscribes the location events for a deferred 5GC-MT-LR procedure (defined in 3GPP TS 23.273 V16.7.0) for Periodic, Triggered and UE Available Location Events. The Edge Vehicle Services module can determine which NEF to submit the request. The Edge Vehicle Service module is assumed to be deployed & managed by the edge cloud operated by Telecom operators. Before its deployment, it should follow Telecom operators' security requirement and pass the security review.
Step 703, Edge Vehicle Services Module sends the Nnef_EventExposure_Subscribe message to subscribe the location events for a deferred 5GC-MT-LR procedure (defined in spec 3GPP TS 23.273) for Periodic, Triggered and UE Available Location Events. NEF provides a means of accessing location services to an AF (herein Edge Vehicle Services Module acts as an AF). The Edge Vehicle Services Module can determine which NEF to submit the request. The Edge Vehicle Service Module is assumed to be deployed & managed by the edge cloud operated by Telecom operators. Before its deployment, it should follow Telecom operators' security requirement and pass the security review.

Table 1 is the key attributes for the message Nnef_EventExposure_Subscribe. The parameters in the table below are mainly referring the Location Service Request defined in spec 3GPP TS 23.271 V16.0.0 (Herein the contents of standard 3GPP TS 23.271 V16.0.0 are all incorporated in the invention).

TABLE 1

| Attribute | Data Type | Description |
|---|---|---|
| ueId | Array | Target UE identities |
| serviceId | Integer | Service identity (optional) |
| eventType | Enum | Type of Event definition i.e., “UE |
| | | available”, “change of area”, “motion” or |
| | | “periodic location”. |
| | | Change of area is used for this service. |
| eventReportType | Enum | Indication of either a single event report |
| | | or multiple event reports; |
| minInterval | Integer | Minimum time interval between area |
| | | event reports, if multiple event reports are |
| | | requested; |
| locatinoReqEst | Boolean | Indication of the requested location |
| | | estimate, i.e., whether the location |
| | | estimate of the target UE should be |
| | | contained in the change of area event |
| | | report; |
| maxInterval | Integer | Maximum time interval between reports. |
| | | The maximum reporting time enables the |
| | | Edge service and 5GC/EPC remain aware |
| | | of continuing support by the UE for the |
| | | area event; |
| servieTime | Char | Start time, stop time |
| locationType | Enum | Requested type of location, i.e., “current |
| | | location”, “current or last known location” |
| | | or “initial location” |
| | | “current location” is used for this service. |
| velocity | Boolean | Velocity of the UE (optional) |
| serviceCoverage | Char | Service coverage (i.e., E.164 country |
| | | codes for geographic areas, ITU-T |
| | | Recommendation E.164 [23]) (optional); |
| targetArea | Array | Target area, i.e., geographical area |
| | | expressed as one of the following formats, |
| | | a) a shape defined in 3GPP TS 23.032 |
| | | V17.0.0. |
| | | b) local coordinate system for LCS Client |
| | | e.g., using the OMA MLP protocol. |
| | | c) E.164 country code for a geographic |
| | | area for LCS Client e.g., using the OMA |
| | | MLP protocol. |
| | | d) PLMN identity for LCS Client e.g., |
| | | using the OMA MLP protocol. |
| | | e) geopolitical name of the area (e.g., |
| | | London) for LCS Client e.g., using the |
| | | OMA MLP protocol; |

Step 704, NEF forward the subscription message Ngmlc_Location_ProvideLocation_Req to 5GC/EPC.
Step 705, 5GC/EPC check the target privacy data information for target UEs, translate the target area as the identities of one or more radio cells or tracking areas, determine if it is a roaming UE/Vehicle. If the 5GC/EPC supports the location request, it returns an ack to NEF.
Step 706, NEF forwards the ack message Nnef_Event_Exposure_Notify message to Edge Vehicle Service module.

Table 2 shows the key attributes for the message Nnef_EventExposure_Notify in. The parameters in the table 2 below are mainly referring the Location Service Response defined in spec 3GPP TS 23.271 V16.0.0 (2020-07).

TABLE 2

| Attribute | Data Type | Description |
|---|---|---|
| ueLocation | Array | Location indication of UE in |
| | | geographical coordinates expressed as a |
| | | shape as defined in TS 23.032 or using |
| | | the OMA MLP protocol, local |
| | | coordinate system; |
| ueVelocity | Integer | Velocity of the UE as defined in TS |
| | | 23.032 [8], if requested and if available; |
| timeStamp | Char | Time stamp of location estimate; |
| ueEvent | Char | Indication when UE enters, is within or |
| | | leaves the Geographical area, if needed; |

Step 707, Edge Vehicle Service module sends back the Vehicle_Service_Subscribe_ack Message to the Connected-Vehicle app module.
Step 708, 5GC/EPC detects the event of the UE or a group of UE move in, or leave, or stay in the target area.
Step 709, When 5GC/EPC detects the event occurs, it sends out the event notification message Ngmlc_Location_EventNotify to NEF.
Step 710, NEF forward the event notification to Edge Vehicle Service module via Nnef_EventExposure_Notify message.
Step 711, Edge Vehicle Service module processes the event notifications periodically and filter out which UEs move in, leave out the area.
Step 712, Edge Vehicle Service module sends the UE event list to the Connected-Vehicle app module.

With the embodiments of the present disclosure, the Connected-Vehicle app module can set the upload interval of the vehicle dynamically based on the location of the vehicle.

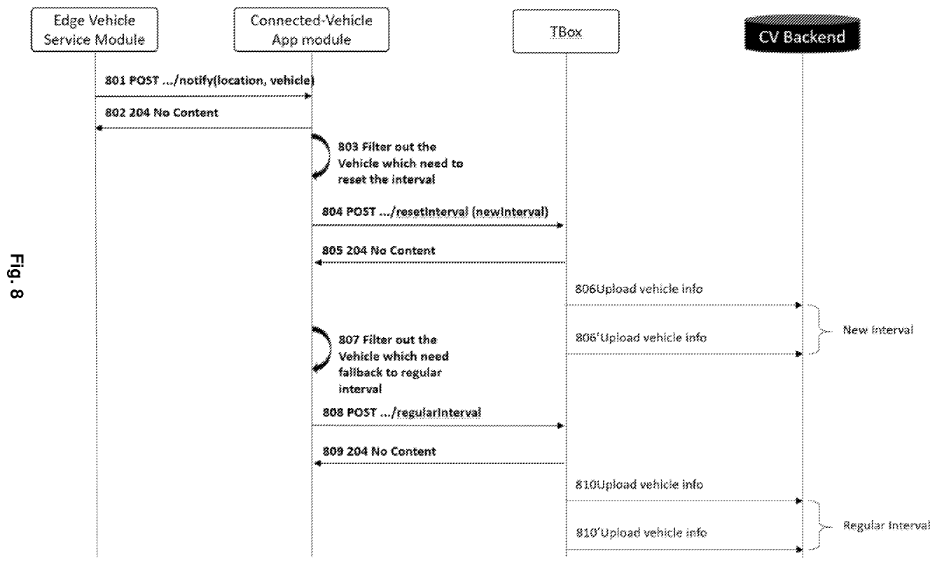

FIG. 8 show the procedure of how to change the interval in TBox.
Step 801, Edge Vehicle Service module sends to the Connected-Vehicle app module the UE event list including the information of which UE moves into or out of the target area.
Step 802, Connected-Vehicle app module responds to the Edge Vehicle Service module.
Step 803, Connected-vehicle App module filters out the which vehicle needs to set a new the interval.
Step 804, Connected-vehicle App module sets the new interval on the TBox and sends it to the TBox in the vehicle.
Step 805, TBox in the vehicle responds to Connected-vehicle App module.
Step 806 and 806′, TBox uploads the vehicle information to the CV Backend using the new interval.
Step 807, Connected-vehicle App module filters out the which vehicle needs to fall back to the regular the interval.
Step 808, Connected-vehicle App module sets the interval back to regular on the TBox and sends it to the TBox in the vehicle.
Step 809, TBox in the vehicle responds to Connected-vehicle App module.
Step 810 and 810′, TBox uploads the vehicle information to the CV Backend using the regular interval.

With the embodiments of the present disclosure, the Connected-Vehicle app module can configure the upload interval of the vehicle dynamically based on the location of the vehicle, the vehicle's information can be uploaded to the could server dynamically, the data amount uploaded can be reduced, therefore the wireless communication resources used to upload the data can be saved.

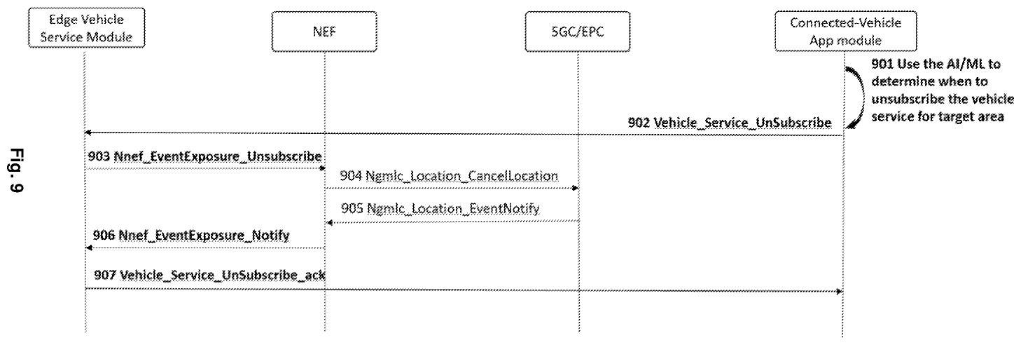

FIG. 9 shows the procedure of how to unsubscribe the Edge Vehicle Service
Step 901, The Connected-vehicle App module determines it is not necessary to collect the UE events for target area, it can unsubscribe the Edge Vehicle Service. In the Connected-Vehicle App module, it can use the AI/ML to figure out the main driving area of the vehicles. If the vehicles don't visit the target area for some time, it can unsubscribe the Edge Vehicle Service.
Step 902, The Connected-vehicle App module sends the vehicle_service_unsubscribe message to the edge vehicle services module to unsubscribe the Edge Vehicle Service.
Step 903, the Edge Vehicle Service module sends the message Nnef_EventExposure_Unsubscribe to NEF.
Step 904, NEF sends the message Ngmlc_Location_CancelLocation to 5GC/EPC.
Step 905, 5GC/EPC makes the subscription successfully and sends the message Ngmlc_Location_EventNotify to the NEF.
Step 906, NEF sends the message Nnef_EventExposure_Notify to the Edge Vehicle Service module.
Step 907, Edge Vehicle Service module sends the message Vehicle_Service_UnSubscribe_ack to Connected-vehicle App module, indicating that the subscription has been made successfully.

With the embodiments of the present disclosure, the subscription of Edge Vehicle Service can be made. When the service is not needed, there is no need for the network to send unnecessary messages or signaling, therefore the network resources are saved.

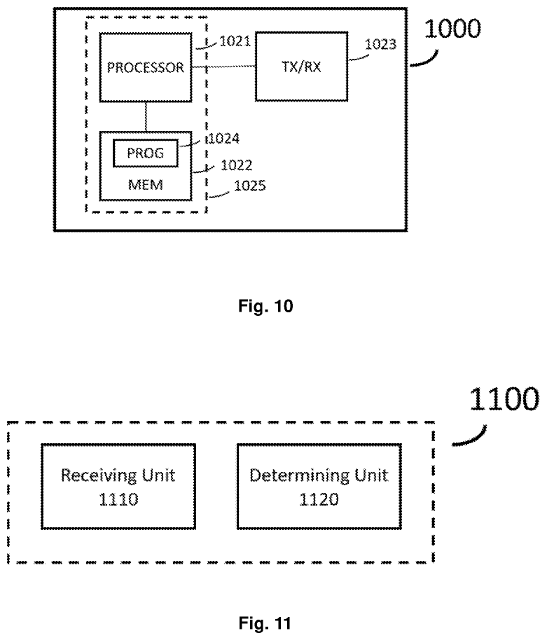

FIG. 10 is a block diagram showing an apparatus suitable for practicing some embodiments of the disclosure. For example, any one of the control entity, service entity, and terminal device described above may be implemented as or through the apparatus 1000.

The apparatus 1000 comprises at least one processor 1021, such as a digital processor (DP), and at least one memory (MEM) 1022 coupled to the processor 1021. The apparatus 1020 may further comprise a transmitter TX and receiver RX 1023 coupled to the processor 1021. The MEM 1022 stores a program (PROG) 1024. The PROG 1024 may include instructions that, when executed on the associated processor 1021, enable the apparatus 1020 to operate in accordance with the embodiments of the present disclosure. A combination of the at least one processor 1021 and the at least one MEM 1022 may form processing means 1025 adapted to implement various embodiments of the present disclosure.

Various embodiments of the present disclosure may be implemented by computer program executable by one or more of the processor 1021, software, firmware, hardware or in a combination thereof.

The MEM 1022 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1021 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the control entity, the memory 1022 contains instructions executable by the processor 1021, whereby the control entity operates according to any step of any of the methods related to the control entity as described above.

In an embodiment where the apparatus is implemented as or at service entity, the memory 1022 contains instructions executable by the processor 1021, whereby the service entity operates according to any step of the methods related to the service entity as described above.

In an embodiment where the apparatus is implemented as or at terminal device, the memory 1022 contains instructions executable by the processor 1021, whereby the terminal device operates according to any step of the methods related to the terminal device as described above.

Correspondingly to the method 400, 400′ as described above, a control entity is provided. FIG. 11 is a block diagram of a control entity 1100 according to an embodiment of the present disclosure.

The control entity 1100 is operative to perform the method 400, 400′ as described above in connection with FIG. 4a and FIG. 4b. The control entity 1100 includes a receiving unit 1110 configured to receive a location information of a terminal device from a service entity, wherein the location information indicates the terminal device moves into or out of a target area. The control entity 1100 further includes a determining unit 1120 configured to determine an upload interval parameter for the terminal device based on the location information, wherein the upload interval indicates a period for the terminal device to upload the terminal device related information to a server entity.

The units 1110 and 1120 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4a and FIG. 4b.

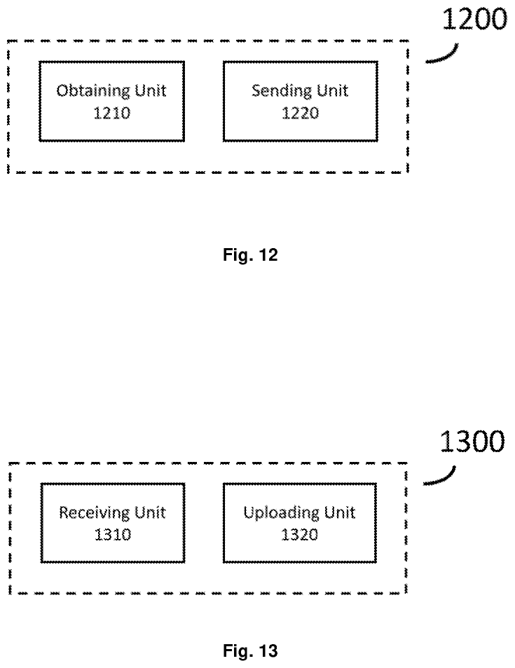

Correspondingly to the method 500, 500′ as described above, a service entity is provided. FIG. 12 is a block diagram of a service entity 1200 according to an embodiment of the present disclosure.

The service entity 1200 is operative to perform the method 500, 500′ as described above in connection with FIG. 5a and FIG. 5b. The service entity 1200 includes an obtaining unit 1210 configured to obtain a location information of a terminal device, wherein the location information indicates the terminal device moves into or out of a target area. The service entity 1200 further includes a sending unit 1220 configured to sending the location information of the terminal device to a control entity.

The units 1210 and 1220 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5a and FIG. 5b.

Correspondingly to the method 600 as described above, a terminal device is provided. FIG. 13 is a block diagram of a terminal device 1300 according to an embodiment of the present disclosure.

The terminal device 1300 is operative to perform the method 600 as described above in connection with FIG. 6. The terminal device 1300 includes a receiving unit 1310 configured to receive an upload interval parameter for the terminal device from a control entity. The terminal device 1300 further includes an uploading unit 1320 configured to upload the terminal device related information to a server entity based on the upload interval parameter.

The units 1310 and 1320 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1.-29. (canceled)

30. A method in a control entity, the method comprising:
receiving location information of a terminal device from a service entity, wherein the location information indicates the terminal device moves into or out of a target area; and
determining an upload interval parameter for the terminal device based on the location information, wherein the upload interval parameter indicates a period for the terminal device to upload terminal device related information to a server entity.

31. The method according to claim 30, further comprising sending the upload interval parameter to the terminal device to configure the terminal device to upload the terminal device related information to the server entity.

32. The method according to claim 30, further comprising sending a first request message for the location information of the terminal device to the service entity, wherein the first request message includes an identifier of the terminal device and information of the target area.

33. The method according to claim 32, wherein the first request message is an edge service subscription message to subscribe to the location information from the service entity.

34. The method according to claim 33, further comprising determining when to send the edge service subscription message.

35. The method according to claim 30, wherein the determining the upload interval parameter comprises:
setting the upload interval parameter to be a first parameter when the location information indicates that the terminal device moves into the target area; and/or
setting the upload interval parameter to be a second parameter when the location information indicates that the terminal device moves out of the target area.

36. The method according to claim 35, wherein the first parameter is larger than the second parameter.

37. The method according to claim 30, wherein the terminal device related information comprises at least one the following:
speed of the terminal device; or
location of the terminal device.

38. The method according to claim 32, wherein the information of the target area is geographical area information which comprises at least one of the following:
geographical information of a high-speed way; or
geographical information of a congested street.

39. The method according to claim 30, wherein the terminal device comprises a vehicle, a mobile phone, or a drone.

40. A method in a service entity, the method comprising:
obtaining location information of a terminal device, wherein the location information indicates the terminal device moves into or out of a target area; and
sending the location information of the terminal device to a control entity.

41. The method according to claim 40, further comprising receiving a first request message for the location information of the terminal device from the control entity, wherein the first request message includes an identifier of the terminal device and information of the target area.

42. The method according to claim 41, wherein the first request message is an edge service subscription message to subscribe to the location information from the service entity.

43. The method according to claim 40, wherein the obtaining the location information comprises:
sending a second request message for the location information of the terminal device to a core network entity; and
receiving the location information of the terminal device from the core network entity.

44. The method according to claim 40, further comprising determining the terminal device moves into or out of the target area which is served by the service entity.

45. The method according to claim 41, wherein the information of the target area is geographical area information which comprises at least one of the following:
geographical information of a high-speed way; or
geographical information of a congested street.

46. The method according to claim 40, wherein the terminal device comprises a vehicle, a mobile phone, or a drone.

47. A method in a terminal device, the method comprising:
receiving an upload interval parameter for the terminal device from a control entity; and
uploading terminal device related information to a server entity based on the upload interval parameter.

48. The method according to claim 47, wherein the upload interval parameter is a first parameter when the terminal device moves into the target area and/or wherein the upload interval parameter is a second parameter when the terminal device moves out of the target area.

49. The method according to claim 48, wherein the first parameter is larger than the second parameter.
